(19) United States
(12) Patent Application Publication
(10) Pub. No.: US 2009/0282830 A1
(43) Pub. Date: Nov. 19, 2009

(54) COMBUSTOR WITH REDUCED CARBON MONOXIDE EMISSIONS

(76) Inventors: Adnan Eroglu, Untersiggenthal (CH); Oliver Riccius, Birmenstorf (CH); Klaus Knapp, Gebenstorf (CH); Peter Flohr, Turgi (CH)

Correspondence Address: CERMAK KENEALY VAIDYA & NAKAJIMA LLP, 515 E. BRADDOCK RD, ALEXANDRIA, VA, 22314, US

(21) Appl. No.: 12/436,910

(22) Filed: May 7, 2009

(30) Foreign Application Priority Data
May 15, 2008 (EP) 08156297.7

(51) Int. Cl. F23R 3/42; F02C 7/24

(52) U.S. Cl. 60/725; 60/722

(57) ABSTRACT

A combustor arrangement for a gas turbine engine (31) has a split line (42) and a plurality of burners (20,37) arranged in an annular ring (40). The burners (46) of the combustor on either side of the split line (42) have a separation distance of at least two times the average separation distance between burners (48) distant from the split line (42).

This application claims priority under 35 U.S.C. §119 to European patent application no. 08156297.7, filed 15 May 2008, the entirety of which is incorporated by reference herein.

### BACKGROUND

1. Field of Endeavor

The invention relates to the design of an annular combustor of a gas turbine engine. More specifically the invention relates to a combustor design with reduced carbon monoxide emissions.

2. Brief Description of the Related Art

A gas turbine engine to which this invention can be applied is shown in FIG. 1 and has the following elements. A compressor 21 compressing air, for use in a high-pressure combustion chamber 22 is fitted with premix burners 20, as well as for cooling. Partially combusted air from the high-pressure combustor 22 passes through a high-pressure turbine 23 before flowing further into a low-pressure combustion 24 chamber where combustion occurs by self-ignition. In this chamber fuel is added to unburnt air from the high-pressure combustor 12 via a lance 37 that defines the burner of the low-pressure combustor 24. Both of the combustors include elongated toroidal shaped combustion chambers surrounding the shaft 30 of the engine and have their burners annularly mounted at one end of the chamber. The hot combustion gases then pass through a low-pressure turbine 25 before passing through a heat recovery steam generator. In order to generate electricity, the compressor 21 and turbines 23,25 drive a generator 26 via a shaft 30.

The burner of the high-pressure combustor is typically a pre-mix burner 20 as shown in FIG. 2. It typically includes a conical swirl shaped body in the form of a double cone 11 which is concentric with the burner axis, wherein the region between the double cone 11 body and burner axis defines a swirl space 17. A central fuel lance 12 lies within the burner axis extending into the swirl space 17. In a first stage 18, pre-mix fuel is injected radially into the swirl space 17 through injection holes in the fuel lance 12 while in a second stage 14, pre-mix fuel is injected through injection holes located in the double cone 11 section of the burner into an air stream conducted within the double cone 11.

In order to facilitate the inspection of a gas turbine engine, each of the combustors is separable along a split plane, forming a split line. The need to break the combustors at the split line means that the split line cannot be totally sealed, resulting in gas leakage of cooling gas from the plenum surrounding the combustor. This leakage results in localized cooling that extends to adjacent burners, resulting in greater formation of CO in these burners than in other burners. When the cooling gas is air, the localized cooling is coupled with increased oxygen concentration, exacerbating the problem.

CO is a restricted gas for emission purposes and so there is a desire to reduce its production. While operating parameters, such as combustor inlet and flame temperature, impact the formation of CO, due to the overriding need to drive engine throughput and efficiency it is undesirable to use these parameters as CO emission control parameters. There is therefore a need for an alternative.

### SUMMARY

One of numerous aspects of the present invention includes a combustor with reduced CO emission.

Another aspect includes the general idea of increasing the burner separation distance in the vicinity of the split plain of a combustor.

Yet another aspect of the invention includes a combustor for a gas turbine engine having a split line and comprising burners arranged in an annular ring characterized by the separation distance between burners either side of the split line being at least two times the average separation distance between burners distant from the split line. The large separation distance reduces CO emissions caused by split line seal leakage. A further advantage is that, due to the significant disruption in the symmetry of the burner arrangement, thermo-acoustic stability is increased, enabling higher burner gas velocities and offsetting what would otherwise be a suboptimal use of available combustor circumferential space.

In a further aspect, the separation distance of the burners either side of the split line is at least four times, but not more than seven times, the average burner separation distance distant from the split line, thus eliminating the impact of split line leakage on the turbine engine CO generating while not extending the distance beyond a point of benefit.

In another aspect, the combustor is the high-pressure combustor of a gas turbine engine and the burners are pre-mix burners, although principles of the invention could also be applied, for example, to the lances of the low-pressure combustor.

In a further aspect, to maximize thermo-acoustic stability, a thermo-acoustic pulsation suppression or dampening device is located between burners either side of the split line, thus efficiently and advantageously utilizing the space made available by the burner arrangement. In a further aspect, the burners either side of the split line are equidistant from the to optimize the separation distance from the split line. Where, however, for example, pulsation suppression devices are fitted towards one side of the split line, as these devices may provide some shielding of burners from leakage gas, the separation distance of burners from the split line on one side of the split line may preferably be different to those on the other side of the split line.

Another aspect of the invention includes overcoming, or at least ameliorating, the disadvantages and shortcomings of the prior art or providing a useful alternative.

Other aspects and advantages of the present invention will become apparent from the following description, taken in connection with the accompanying drawings wherein by way of illustration and example, an embodiment of the invention is disclosed.

### BRIEF DESCRIPTION OF THE DRAWINGS

By way of example, an embodiment of the invention is described more fully hereinafter with reference to the accompanying drawings, in which:

FIG. 1 is a schematic view of a gas turbine engine;

FIG. 2 is a sectional cut away view of a staged premix burner; and

FIG. 3 illustrates a preferred arrangement in accordance with the invention showing a cross sectional end view of circumferentially mounted premix burners of FIG. 2 in a combustor of a gas turbine engine of FIG. 1.

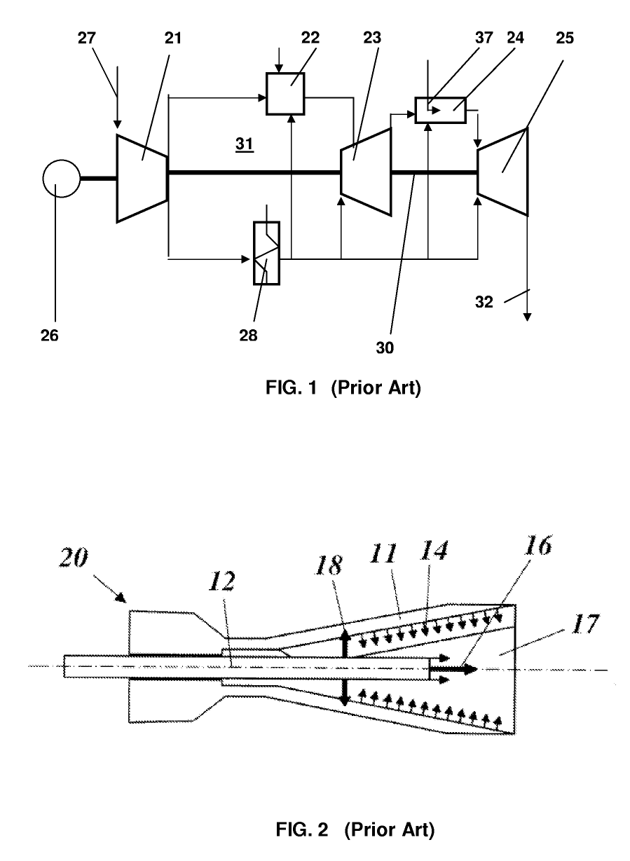

### DETAILED DESCRIPTION OF EXEMPLARY EMBODIMENTS

Preferred exemplary embodiments of the present invention are now described with reference to the drawings, wherein like reference numerals are used to refer to like elements throughout. In the following description, for purposes of explanation, numerous specific details are set forth in order to provide a thorough understanding of the invention. It may be evident, however, that the invention may be practiced without these specific details.

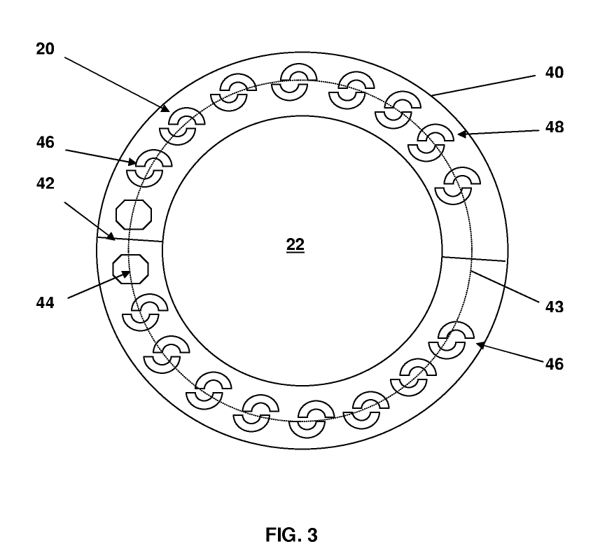

As shown in FIG. 3, an embodiment is illustrated in which burners 46 either side of the split line 42 are located further apart than burners 48 distant from the split line 42 by a factor of at least two, but preferably by at least four, but less than seven, and are preferably spaced such that the split line 42 is approximately equidistant from these burners 46. The separation distance used to determine these factors throughout this specification is measured along an imaginary central arc 43 passing approximately through the axis of each burner, where, in addition, the axis of the burner is also the point of measure. The resulting thermo-acoustic stability resulting from the disrupted spatial symmetry enables higher burner gas rates, offsetting the disadvantage of a possible lower burner count as a result of the less efficient use of the combustor annular space 40.

While the invention is most applicable to the pre-mix burners 20 of a high-pressure combustor 22, as the flame front of this burner is relatively close to the burner tip, the invention can equally be applied to the lances 37 that include the burners of the low-pressure combustor 24.

Further the space around the split line 42 can be used to fit thermo-acoustic vibration suppression or dampening devices 44 such as a Helmholtz resonator.

Although embodiments exemplifying principles of the present invention have been herein shown and described in what is conceived to be the most practical and preferred embodiments, it is recognized that departures can be made within the scope of the invention, which is not to be limited to details described herein but is to be accorded the full scope of the appended claims so as to embrace any and all equivalent devices and apparatus.

### REFERENCE NUMBERS

11. Double cone

12. Fuel lance

18. First stage

14. Second stage

16. Liquid fuel

17. Swirl space

20. Premix burner

21. Compressor

22. High-pressure combustor

23. High-pressure turbine

24. Low pressure combustor

25. Low-pressure turbine

26. Generator

27. Air

28. Air cooler

30. Shaft

31. Gas turbine engine

32. Exhaust gases

37. Low pressure combustor lance

40. Combustor annulus

42 Combustor split line

43. Central arc

44. Thermo-acoustic vibration suppression or dampening device

46. Burner on one side of the split line

48. A burner distant from the split line

While the invention has been described in detail with reference to exemplary embodiments thereof, it will be apparent to one skilled in the art that various changes can be made, and equivalents employed, without departing from the scope of the invention. The foregoing description of the preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments as are suited to the particular use contemplated. It is intended that the scope of the invention be defined by the claims appended hereto, and their equivalents. The entirety of each of the aforementioned documents is incorporated by reference herein.

We claim:

1. A combustor for a gas turbine engine, the combustor comprising:
a split line; and
a plurality of burners arranged in an annular ring;
wherein a separation distance between burners on either side of the split line is at least two times the average separation distance between burners distant from the split line.

2. The combustor of claim 1, wherein the separation distance between said burners on either side of the split line is at least four times, but less than seven times, the average the separation distance between burners distant from the split line.

3. The combustor of claim 1, wherein the combustor comprises a high-pressure combustor of a gas turbine engine and the burners comprise premix burners.

4. The combustor of claim 1, further comprising:
a thermo-acoustic pulsation suppression or dampening device located between burners on either side of the split line.

5. The combustor of claim 1, wherein said burners on either side of the split line are equidistant from the split line.
